(19) United States
(12) Patent Application Publication
(10) Pub. No.: US 2014/0137799 A1
(43) Pub. Date: May 22, 2014

(54) DEPOSITION APPARATUS AND METHOD OF FORMING THIN FILM

(71) Applicant: L G INNOTEK CO., LTD., Seoul (KR)

(72) Inventors: Yeong Deuk JO, Seoul (KR); Moo Seong KIM, Seoul (KR); Seok Min KANG, Seoul (KR)

(73) Assignee: LG INNOTEK CO., LTD., Seoul (KR)

(21) Appl. No.: 14/128,348

(22) PCT Filed: Jan. 9, 2012
(86) PCT No.: PCT/KR2012/000204

§ 371 Date: Dec. 20, 2013

(30) Foreign Application Priority Data
Jun. 20, 2011 (KR) 10-2011-0059858

(51) Int. Cl. G05D 21/02

(52) U.S. Cl. CPC G05D 21/02
USPC 118/691; 118/689

(57) ABSTRACT

A deposition apparatus and a method of forming a thin film are provided. The deposition apparatus includes a reaction gas supply unit supplying a reaction gas, a buffer unit temporarily storing the reaction gas supplied from the reaction gas supply unit, and a deposition unit forming a thin film by using the reaction gas supplied from the buffer unit.

### TECHNICAL FIELD

The present disclosure relates to a deposition apparatus and a method of forming a thin film.

### BACKGROUND ART

In general, a chemical vapor deposition (CVD) method is frequently used among the techniques of forming various thin films on a substrate or a wafer. The CVD method is a deposition technique accompanying a chemical reaction and forms a semiconductor thin film or an insulation layer on the surface of a wafer by using the chemical reaction of a source material.

The CVD method and the deposition apparatus receive attention as very important techniques among thin film forming techniques according to the recent miniaturization of semiconductor devices and development of a high efficiency and high power light-emitting diode (LED). Currently, the CVD method is used for depositing various thin films, such as a silicon layer, an oxide layer, a silicon nitride layer or a silicon oxynitride layer, or a tungsten layer, on a wafer.

### DISCLOSURE OF INVENTION

### Technical Problem

Embodiments provide a deposition apparatus for forming a thin film having improved quality at an improved rate through precise flow control and a method of forming the thin film.

### Solution to Problem

In one embodiment, a deposition apparatus includes: a reaction gas supply unit supplying a reaction gas; a buffer unit temporarily storing the reaction gas supplied from the reaction gas supply unit; and a deposition unit forming a thin film by using the reaction gas supplied from the buffer unit.

In another embodiment, a method of forming a thin film includes: evaporating a liquid to form a reaction gas; temporarily storing the reaction gas in a buffer unit; supplying the reaction gas temporarily stored in the buffer unit to a deposition unit; and forming a thin film by using the reaction gas supplied from the buffer unit.

The details of one or more embodiments are set forth in the accompanying drawings and the description below. Other features will be apparent from the description and drawings, and from the claims.

### Advantageous Effects of Invention

The deposition apparatus according to an embodiment of the present invention may accurately control the amount of the reaction gas supplied to a deposition unit by using a buffer unit. Therefore, the deposition apparatus according to the embodiment of the present invention may form a thin film on a wafer at a uniform and constant rate by using the buffer unit.

In particular, the deposition apparatus according to the embodiment of the present invention may supply the reaction gas in an amount for growing the thin film at an optimum rate to the deposition unit. Therefore, the deposition apparatus according to the embodiment of the present invention may form the thin film at an improved rate.

### BRIEF DESCRIPTION OF DRAWINGS

FIG. 1 illustrates an apparatus for growing a silicon carbide epitaxial layer according to an embodiment of the present invention;

FIG. 2 is a perspective view illustrating a buffer unit;

FIG. 3 is a perspective view illustrating a deposition unit; and

FIG. 4 is a cross-sectional view illustrating a cross-section of the deposition unit.

### BEST MODE FOR CARRYING OUT THE INVENTION

Reference will now be made in detail to the embodiments of the present disclosure, examples of which are illustrated in the accompanying drawings.

In the description of embodiments, it will be understood that when a layer (or film), region, pattern or structure is referred to as being ‘on’ another layer (or film), region, pad or pattern, the terminology of ‘on’ and ‘under’ includes both the meanings of ‘directly’ and ‘indirectly’. Further, the reference about ‘on’ and ‘under’ each layer will be made on the basis of drawings.

Since the thickness or size of each layer (or film), region, pattern or structure in the drawings may be modified for convenience in description and clarity, the size of each element does not entirely reflect an actual size.

Hereinafter, an embodiment of the present invention is described in detail.

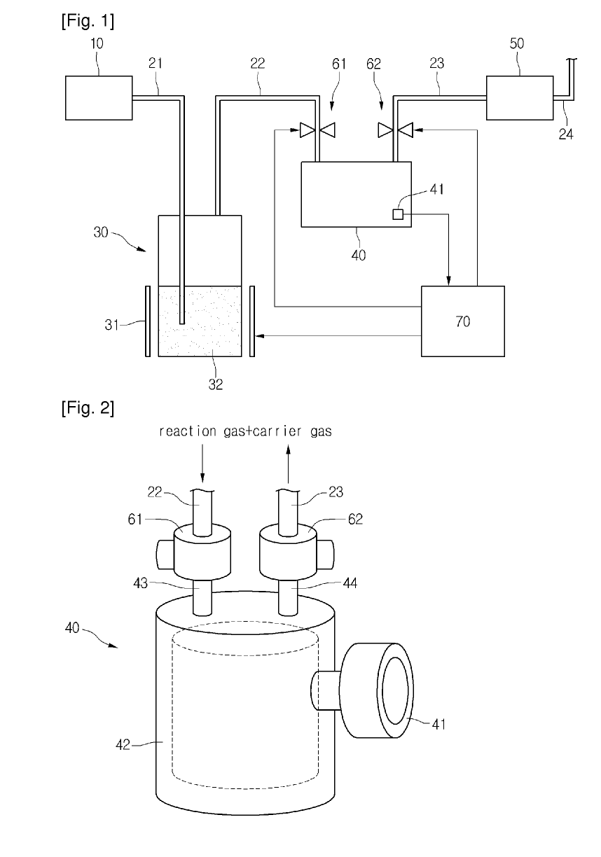

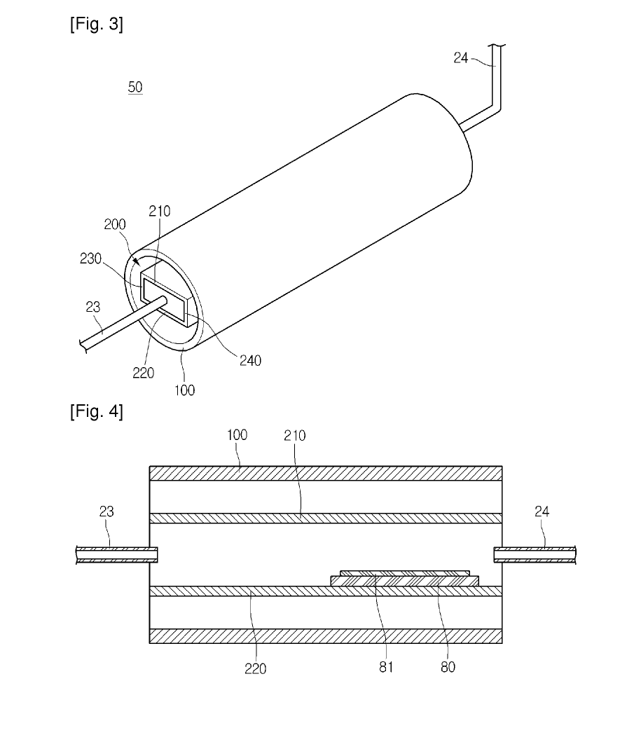

FIG. 1 illustrates an apparatus for growing a silicon carbide epitaxial layer according to an embodiment of the present invention. FIG. 2 is a perspective view illustrating a buffer unit. FIG. 3 is a perspective view illustrating a deposition unit. FIG. 4 is a cross-sectional view illustrating a cross-section of the deposition unit.

Referring to FIGS. 1 to 4, the apparatus for growing a silicon carbide epitaxial layer according to an embodiment of the present invention includes a carrier gas supply unit 10, a reaction gas supply unit 30, a buffer unit 40, a deposition unit 50, a first flow control unit 61, a second flow control unit 62, a sensor unit 41, and a control unit 70.

The carrier gas supply unit 10 supplies a carrier gas to the reaction gas supply unit 30. The carrier gas has a very low reactivity. Examples of the carrier gas may be nitrogen or inert gas. In particular, the carrier gas supply unit 10 may supply the carrier gas to the reaction gas supply unit 30 through a first supply line 21.

The reaction gas supply unit 30 generates the reaction gas. Also, the reaction gas supply unit 30 stores a liquid 32 for generating the reaction gas. For example, the reaction gas may be formed by evaporation of the liquid 32.

An end of the first supply line 21 may be immersed in the liquid 32. As a result, the carrier gas is supplied into the liquid 32 through the first supply line 21. Thus, bubbles including the carrier gas may be formed in the liquid 32.

The liquid 32 and the reaction gas may include a compound containing silicon and carbon. For example, the liquid 32 and the reaction gas may include methyltrichlorosilane (MTS).

The reaction gas supply unit 30 includes a heat generating unit 31 that applies heat to the liquid 32. The heat generating unit 31 may evaporate the liquid 32 by applying heat to the liquid 32. An amount of evaporated reaction gas may be appropriately adjusted according to the amount of heat applied by the heat generating unit 31.

The reaction gas supply unit 30 supplies the reaction gas to the buffer unit 40 through the second supply line 22. That is, the reaction gas is supplied to the buffer unit 40 by means of the reaction gas supply unit 30, the flow of the carrier gas, and the evaporation of the liquid 32.

The buffer unit 40 is connected to the second supply line 22. The buffer unit 40 is supplied with the reaction gas from the reaction gas supply unit 30 through the second supply line 22. The buffer unit 40 temporarily stores the reaction gas. That is, the buffer unit 40 temporarily stores the reaction gas, and then supplies the reaction gas to the deposition unit 50.

Referring to FIG. 2, the buffer unit 40 includes a container 42 for containing the reaction gas, an inlet 43 introducing the reaction gas, and an outlet 44 discharging the reaction gas.

Also, a volume of the container 42 may be in a range of about 5 l to about 20 l. The second supply line 22 is connected to the inlet 43. A third supply line 23 is connected to the outlet 44. Further, both of the inlet 43 and the outlet 44 may be formed at an upper portion of the container 42.

The deposition unit 50 contains a wafer 80 or a substrate for forming an epitaxial layer 81. The deposition unit 50 forms the epitaxial layer 81 by using the reaction gas. That is, the deposition unit 50 forms a thin film 81 on the wafer 80 or the substrate by using the reaction gas.

Referring to FIGS. 3 and 4, the deposition unit 50 includes an induction heat generating unit 100 and a susceptor 200. Also, the deposition unit 50 may further include a chamber containing the susceptor 200, a heat insulating unit, and a wafer holder.

The induction heat generating unit 100 encloses the susceptor 100. The induction heat generating unit 100 may generate heat by induction heating. The heat generated by the induction heat generating unit 100 may be transferred to the inside of the susceptor 200.

Examples of the material used for the induction heat generating unit 100 may be graphite or the like. The induction heat generating unit 100 may have a tube shape. The induction heat generating unit 100 may enclose the susceptor 200.

The susceptor 200 contains the wafer 80 or the substrate. Also, the reaction gas is introduced from the buffer unit 40 into the susceptor 200.

As illustrated in FIGS. 3 and 4, the susceptor 200 may include an upper susceptor plate 210, a lower susceptor plate 220, and side susceptor plates 230 and 240. Also, the upper susceptor plate 210 and the lower susceptor plate 220 are disposed to face to each other.

The upper susceptor plate 210 and the lower susceptor plate 220 are disposed and the side susceptor plates 230 and 240 are disposed at both sides thereof, and then the susceptor 200 may be manufactured by bonding one another.

However, the embodiment of the present invention is not limited thereto, and the susceptor 200 may be manufactured by making a space for gas passage in a rectangular susceptor 200.

A wafer holder, which may fix a deposition subject, the wafer 80 or the substrate, may further be disposed on the lower susceptor plate 220.

A deposition process may be performed while air flows in the space between the upper susceptor plate 210 and the lower susceptor plate 220. The side susceptor plates 230 and 240 act to prevent the reaction gas from flowing out when the air flows inside the susceptor 200.

The susceptor 200 may include graphite having high heat resistance and good machinability in order to endure under conditions of high temperatures or the like. Also, the susceptor 200 may have a structure in which a graphite body is coated with silicon carbide. Further, the susceptor 200 itself may be inductively heated.

The reaction gas supplied to the susceptor 200 is decomposed into radicals by means of heat and may be deposited on the wafer 80 in the above-mentioned state. For example, MTS is decomposed into radicals including silicon or carbon and a silicon carbide epitaxial layer may be grown on the wafer 80. More particularly, the radicals may be CH3?, CH4, SiCl3?, or SiCl2?.

The gas remaining after forming the silicon carbide epitaxial layer may be discharged outside through an exhaust line 24 disposed at the end of the susceptor 200.

The first flow control unit 61 is disposed between the reaction gas supply unit 30 and the buffer unit 40. More particularly, as shown in FIG. 2, the first flow control unit 61 is included in the second supply line 22. More particularly, the first flow control unit 61 may be disposed near the buffer unit 40.

The first flow control unit 61 may adjust the flow of the reaction gas supplied from the reaction gas supply unit 30 to the buffer unit 40. More particularly, the first flow control unit 61 may adjust the amounts of the reaction and carrier gases supplied from the reaction gas supply unit 30 to the buffer unit 40. Also, the first flow control unit 61 may be controlled by the control unit 70.

The second flow control unit 62 is disposed between the buffer unit 40 and the deposition unit 50. More particularly, the second flow control unit 62 is included in the third supply line 23. Also, a shown in FIG. 2, the second flow control unit 62 may be disposed near the buffer unit 40.

The second flow control unit 62 may adjust the flow of the reaction gas supplied from the buffer unit 40 to the deposition unit 50. More particularly, the second flow control unit 62 may adjust the amounts of the reaction and carrier gases supplied from the buffer unit 40 to the deposition unit 50. Also, the second flow control unit 62 may be controlled by the control unit 70.

The sensor unit 41 measures a concentration of the reaction gas in the buffer unit 40. The sensor unit 41 supplies the measured concentration to the control unit 70. The sensor unit 41 may measure the concentration of the reaction gas by using an absorption spectrum with respect to infrared rays. For example, the sensor unit 41 may include a non-dispersive infrared absorption (NDIR) sensor. In addition, the sensor unit 41 may measure the concentration of the reaction gas with various methods.

The control unit 70 controls the first flow control unit 61, the second flow control unit 62, and the heat generating unit 31 based on the concentration of the reaction gas input from the sensor unit 41. For example, when the concentration of the reaction gas in the buffer unit 40 is lower than a reference value, the control unit 70 may increase the amount of the reaction gas supplied to the deposition unit 50 by controlling the first flow control unit 61 and the second flow control unit 62. Also, the control unit 70 may increase the evaporation amount of the liquid 32 by increasing the heat generation amount of the heat generating unit 31 when the concentration of the reaction gas in the buffer unit 40 is lower than the reference value.

Further, when the concentration of the reaction gas in the buffer unit 40 is higher than the reference value, the control unit 70 may decrease the amount of the reaction gas supplied to the deposition unit 50 by controlling the first flow control unit 61 and the second flow control unit 62. Also, the control unit 70 may decrease the evaporation amount of the liquid 32 by decreasing the heat generation amount of the heat generating unit 31 when the concentration of the reaction gas in the buffer unit 40 is higher than the reference value.

Thus, the apparatus for growing a silicon carbide epitaxial layer according to an embodiment of the present invention may effectively form a silicon carbide epitaxial layer by using the buffer unit 40. That is, the reaction gas supply unit 30 evaporates the liquid 32 to form the reaction gas. The reaction gas is temporarily stored in the buffer unit 40, and then is supplied to the deposition unit 50. The reaction gas thus supplied is decomposed into radicals to form an epitaxial layer on the wafer 80.

Also, the concentration of the reaction gas in the buffer unit 40 is measured through the sensor unit 41 and the amount of the reaction gas supplied into the deposition unit 50 may easily be adjusted by the control unit 70, the first flow control unit 61, the second flow control unit 62, and the heat generating unit 31.

Therefore, the apparatus for growing a silicon carbide epitaxial layer according to the embodiment of the present invention may form a thin film 81 such as the silicon carbide epitaxial layer on the wafer 80 at a uniform and constant rate by using the buffer unit 40.

In particular, the apparatus for growing a silicon carbide epitaxial layer according to the embodiment of the present invention may supply the reaction gas in an amount for growing the thin film 81 at an optimum rate to the deposition unit 50. Therefore, the apparatus for growing a silicon carbide epitaxial layer according to the embodiment of the present invention may form the thin film 81 at an improved rate.

The foregoing apparatus for growing a silicon carbide epitaxial layer may correspond to a deposition apparatus for forming the thin film 81 on the wafer 80.

Features, structures, or effects described in the foregoing embodiment are included in at least one embodiment of the present invention, and are not necessarily limited to only one embodiment thereof. Further, the features, structures, or effects exemplified in each embodiment may be combined or modified by those skilled in the art and implemented to other embodiments thereof. Therefore, descriptions related to such combinations and modifications will be construed as being included in the scope of the present invention.

Also, while this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

1. A deposition apparatus comprising:
a reaction gas supply unit supplying a reaction gas;
a buffer unit temporarily storing the reaction gas supplied from the reaction gas supply unit; and
a deposition unit forming a thin film by using the reaction gas supplied from the buffer unit.

2. The deposition apparatus according to claim 1, wherein the deposition apparatus comprises a first flow control unit controlling a flow of the reaction gas supplied from the reaction gas supply unit to the buffer unit.

3. The deposition apparatus according to claim 2, wherein the deposition apparatus comprises a sensor unit measuring a concentration of the reaction gas in the buffer unit.

4. The deposition apparatus according to claim 3, wherein the deposition apparatus comprises a control unit controlling the first flow control unit, and the concentration of the reaction gas measured by the sensor unit is input to the control unit.

5. The deposition apparatus according to claim 1, wherein the reaction gas comprises methyltrichlorosilane (MTS), and the thin film comprises silicon carbide.

6. The deposition apparatus according to claim 1, wherein a carrier gas is supplied to the reaction gas supply unit, and the reaction gas and the carrier gas are supplied to the buffer unit at the same time.

7. The deposition apparatus according to claim 2, wherein the deposition apparatus comprises a second flow control unit controlling a flow of the reaction gas supplied from the buffer unit to the deposition unit.

8. The deposition apparatus according to claim 7, wherein the deposition apparatus comprises a sensor unit measuring a concentration of the reaction gas in the buffer unit.

9. The deposition apparatus according to claim 8, wherein the deposition apparatus comprises a control unit controlling the second flow control unit, and the concentration of the reaction gas measured by the sensor unit is input to the control unit.

10-15. (canceled)

16. The deposition apparatus according to claim 1, wherein the buffer unit includes a container for containing the reaction gas, an inlet introducing the reaction gas, and an outlet discharging the reaction gas.

17. The deposition apparatus according to claim 8, wherein the sensor unit includes a non-dispersive infrared absorption (NDIR) sensor.

18. The deposition apparatus according to claim 8, further comprising;
a control unit,
wherein the control unit controls the first flow control unit, the second flow control unit, and the heat generating unit based on the concentration of the reaction gas input from the sensor unit.

19. The deposition apparatus according to claim 18,
wherein the control unit increases the amount of the reaction gas supplied to the deposition unit by controlling the first flow control unit and the second flow control unit when the concentration of the reaction gas in the buffer unit is lower than a reference value.

20. The deposition apparatus according to claim 18,
wherein the control unit increases the evaporation amount of the liquid by increasing the heat generation amount of the heat generating unit when the concentration of the reaction gas in the buffer unit is lower than the reference value.

21. The deposition apparatus according to claim 18,
wherein the control unit decreases the amount of the reaction gas supplied to the deposition unit by controlling the first flow control unit and the second flow control unit when the concentration of the reaction gas in the buffer unit is higher than the reference value.

22. The deposition apparatus according to claim 18,
wherein the control unit decreases the evaporation amount of the liquid by decreasing the heat generation amount of the heat generating unit when the concentration of the reaction gas in the buffer unit is higher than the reference value.
